(19) United States
(12) Patent Application Publication
(10) Pub. No.: US 2002/0013689 A1
(43) Pub. Date: Jan. 31, 2002

(54) Electric power generation process and apparatus

(76) Inventor: Thomas R. Hunton, Chelmsford, MA (US)

Correspondence Address: ARENT FOX KINTNER PLOTKIN & KAHN, 1050 CONNECTICUT AVENUE, N.W., SUITE 600, WASHINGTON, DC, 20036, US

(21) Appl. No.: 09/859,669

(22) Filed: May 18, 2001

Related U.S. Application Data
(60) Provisional application No. 60/205,289, filed on May 19, 2000.

(51) Int. Cl. G06F 17/50

(52) U.S. Cl. 703/18

(57) ABSTRACT

One embodiment of the invention provides an electric power generation system. The system includes an electric power generator. A second electric meter is connected to the power generator and an electric power consumer. The second meter measures electric power generated by the power generation system. A first electric meter is connected to an electric power distribution line. The power line supplies electric power from an electric grid and receives surplus power from the power generator. Thus, the first meter measures a net electric power provided to the electric power consumer through the electric power line.

### CROSS-REFERENCES TO RELATED APPLICATIONS

This invention claims the benefit of U.S. Provisional Application No. 60/205,289 filed May 19, 2000, the contents of which are hereby incorporated by reference.

### BACKGROUND OF THE INVENTION

1. Field of the Invention

This invention relates generally to processes and apparatuses employed to generate electric power, and particularly to solar, wind, or other ecologically friendly distributed electric power generation processes and apparatuses.

2. Description of the Related Art

Residential electricity service is broken down into three categories: generation, transmission, and distribution. Power plants produce electricity (generation), which is transmitted to customers via wires owned by utilities (transmission and distribution). Thus, a customer's electric bill may show an amount reflecting a generation charge (for example, the generation price per KWh paid by the customer multiplied by the number of KWh consumed) and an amount reflecting a transmission and distribution charge (for example, the transmission and distribution price per KWh paid by the customer multiplied by the number of KWh consumed)

In a conventional regulated market, utility distribution companies (UDCs) bill customers a bundled rate for electricity service defined as the sum of generation, transmission, and distribution charges associated with their usage. In deregulated markets, customers can choose to purchase the generation portion of their bills (i.e., what resources are used to produce the power) from UDCs or electricity service providers (ESPs). In either case, UDCs charge customers regulated rates for transmission and distribution, as they own the wires needed for delivery of electricity.

A number of states, including California, offer customers the opportunity to generate power on the premises of their homes and businesses. Solar (photovoltaic) systems are commonly installed for such purposes. When electric output exceeds on-site demand the electric meter operates to decrement the total power consumption indicated on the meter. The reduction in the indicated consumption corresponds to the surplus generated. The meter increments when the on-site demand exceeds the electric output of the solar or other generation system. Thus, net metering enables a customer to only pay for the difference between their total annual power consumption and the annual power output from the on-site generation system.

Net-metered customers effectively reduce their bills by replacing UDC or ESP electricity with self-generated power. However, as in California, UDCs are often not required to purchase surplus power. Therefore, a customer receives no benefit if the customer generates an annual net surplus power (i.e. generates more power in a year than the customer consumes). Consequently, the value of each KWh of electricity generated has the same value per KWh as the combination of the price per KWh paid for generation and price per KWh paid for transmission and distribution until the customer generates, on an annual basis sufficient power to provide for the customers annual power consumption. Thereafter, the power generated has no cash value for the customer.

FIG. 1 contains a table that provides an example of the impact of net-metering on a hypothetical customer that installs a roof top solar (photovoltaic) power generation system. While the example demonstrates electricity bill savings of 42%, the payback period, the period of time over which the solar system generates enough savings to recover the installation costs, for a residential solar system is still well over ten years. It should be noted that these savings are for demonstration only, and the actual amount will only be determined in the field, based on system sizing and orientation, regional solar resource, and electricity prices.

Therefore, there is a need, particularly when electric demand exceeds electric generating capacity in some parts of the United States, for a process and apparatus whereby the payback period for a solar, wind, or other power generation system can be reduced. A reduced payback period is expected to provide motivation for the installation of electric power generation capacity.

### SUMMARY OF THE INVENTION

The invention provides an electric power generation system. The system includes an electric power generator. A second electric meter is connected to the power generator and the electric power consumer. The second meter measures the electric power provided by the power generation system. A first electric meter is connected to a distribution power line. The power line supplies electric power from an electric grid and receives surplus power from the electric power generator. Thus, the first meter measures the net electric power provided to the electric power consumer through the electric power line.

The invention also provides an electric power generation system where a first meter is connected to an electric power line. The power line supplies electric power from the electric grid. The first meter measures the electric power utilized by the electric power consumer. A second electric meter is connected between the power generation system and either the electric grid, a utility side of the first meter, or a connection point between the first meter and the power line. The second meter measures the electric power provided by the power generation system.

The invention provides a method of purchasing electric power from an electric power customer who also generates electricity by setting a price per unit amount of electric power for electric power generated by the electric power customer at a price per unit amount of electric power that exceeds a generation price per unit amount of electric power paid by the electric power customer for electric power consumed. The generated electric power is purchased from the electric power customer at the set price per unit amount of electric power

The invention provides a method of billing for electric power consumed and paying for electric power produced. The method includes charging an electric power consumer a generation charge for the total electric power consumed, the charge determined by multiplying a first rate by the amount of electric power consumed or estimated to have been consumed. In addition, the electric power consumer is paid or credited a generation fee, the fee determined by multiplying a second rate by the amount of electric power generated or estimated to have been generated, the second rate being higher than the first rate.

Some ecologically-friendly ESP's market electricity blends-electricity service based on power generated by a mixture of renewable (or other accepted ecologically friendly) resources. In practice this means that the ecologically friendly ESP schedules the delivery of electricity to the power grid for customers with a promise that the electricity delivered is generated by specific resources. For example, a blend could be 95% small hydroelectric and 5% solar. By blending more expensive resources (e.g., solar) with less costly resources (e.g., small hydroelectric), an ecologically friendly ESP helps advance renewable energy development and keep the costs of its blends at reasonable levels.

### BRIEF DESCRIPTION OF THE DRAWINGS

The accompanying drawings incorporated in and forming part of the specification illustrate several aspects of the present invention, and together with the description explain the principles of the invention. In the drawings:

FIG. 1 illustrates the prior art process of net metering

FIG. 2 illustrates the process of the present invention.

FIG. 3 illustrates a first embodiment of the apparatus of the present invention.

FIG. 4 illustrates a second embodiment of the apparatus of the present invention.

FIG. 5 illustrates a third embodiment of the apparatus of the present invention.

FIG. 6 illustrates a fourth embodiment of the apparatus of the present invention.

FIG. 7 illustrates a flow chart for a first process for performing the present invention.

FIG. 8 illustrates a flow chart for a second process for performing the present invention.

Reference will now be made in detail to the present preferred embodiment of the invention, examples of which are illustrated in the accompanying drawings.

### DETAILED DESCRIPTION OF INVENTION

The present invention offers a process and apparatus that improves the economics of solar, wind, and other electric generation systems.

With this invention, an ESP or UDC effectively treats a solar, wind, or other electric generation system as a small power plant and enters into a power purchase agreement (PPA) with the owner of the system. Each PPA specifies a price per kWh and the term of the contract. This arrangement may add a second meter to measure the generation system's output. In lieu of adding a second meter, it's possible to estimate system output (based on system size, orientation, and regional solar resource).

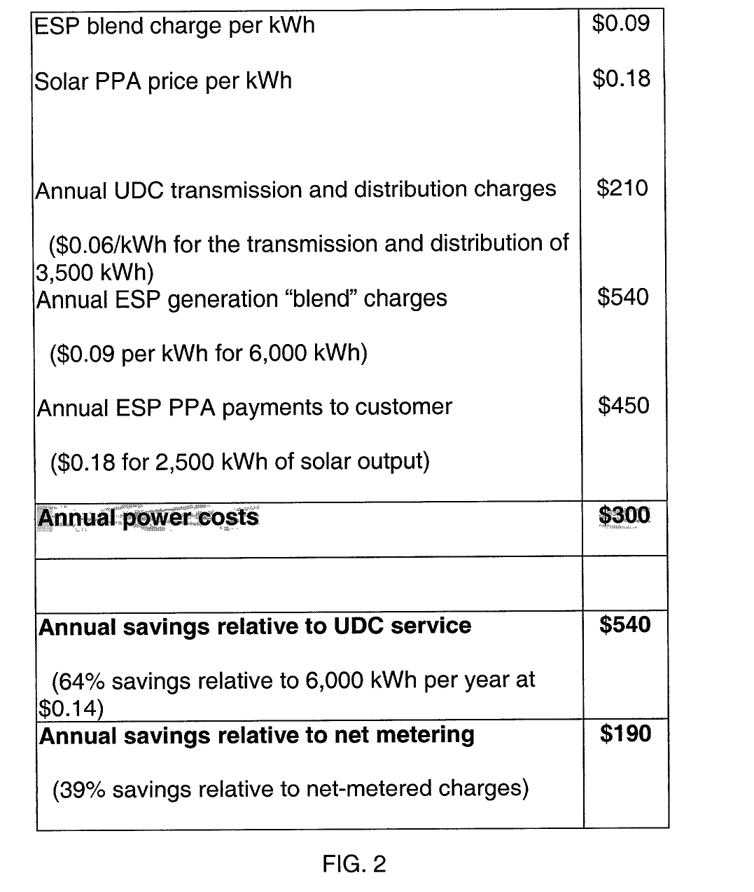

FIG. 2 illustrates an example where the ESP or UDC delivers electricity to the customer and charges the customer based on total consumption. The customer also sells solar power, in this example, to the ESP or UDC from which the customer purchases electricity. In this example, the ESP sells 6,000 kWh of its electricity blend and simultaneously purchases 2,500 kWh of solar output at prices above the cost of the blend.

As with net metering, UDCs charge for the transmission and distribution associated with the net delivered power (total power consumed less power generated) as measured in kWh.

Because the scenario illustrated in FIG. 2 provides a smaller net electric cost, a greater annual savings, and/or a revenue stream to the customer, the economics of the rooftop solar system are improved. The numbers provided in FIG. 2 are for demonstration only. Actual costs and savings will vary based on numerous factors and may have larger or smaller impacts than shown.

Consequently, this invention can reduce the payback period for solar, wind, and other power generation systems and thus increase the likelihood that a customer would purchase a solar, wind or other power generation system. Therefore, the economics of such systems are improved, and the market broadened.

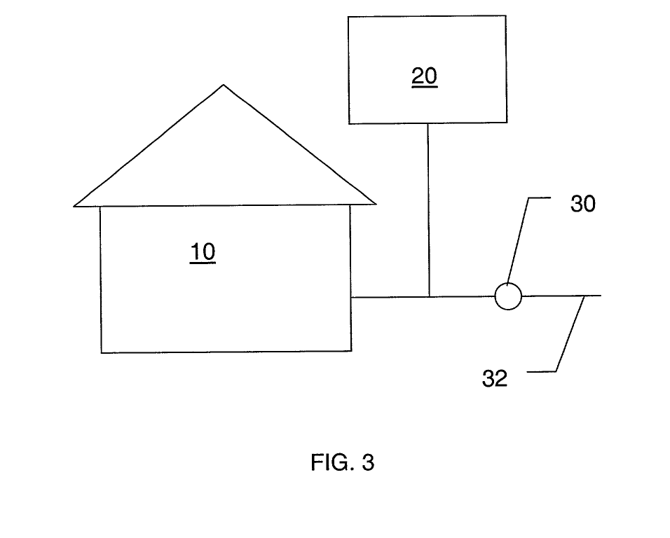

FIG. 3 illustrates a first embodiment of the apparatus that may be used to implement the present invention under a current net-metered arrangement. A customer 10 uses the electric power generated by a solar, wind, or other electric power generator 20. Customer 10 may be a residential customer or a corporate customer. Electric power provided by an ESP or UDC is provided to customer 10 through an electric meter 30 that is connected to the electric grid with power line 32. In this embodiment, the generator 20 is connected to customer 10 on the customer side of meter 30. Consequently, when the power generated by generator 20 exceeds the demand by customer 10 the meter 30 operates to decrement the total power consumption indicated on the meter. The reduction in the indicated consumption corresponds to the surplus power generated. The meter increments when the on-site demand exceeds the electric output of the solar or other generation system.

In this embodiment, it is preferred that customer 10 purchase the electricity from the same ESP or UDC to which the solar, wind, or other electric power is sold. Since there is only a single meter, the ESP or UDC and the customer would estimate the amount of power generated in a given period of time. This estimate could be used in a yearly, monthly, quarterly, or other periodicity calculation to estimate the total power generated and the total power consumed for that period. The customer 10 could then receive a payment or credit for the power generated as illustrated in FIG. 2. This estimation process may require regulatory changes or acceptance by customers.

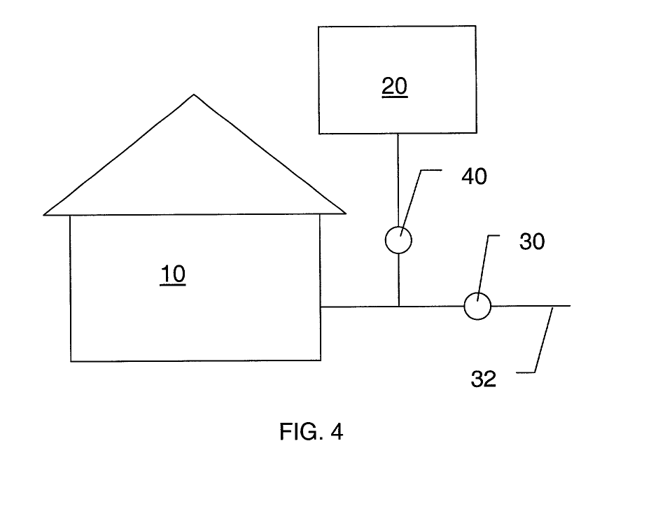

FIG. 4 illustrates a second embodiment of an apparatus that may be used to implement the present invention. Customer 10 uses the electric power generated by a solar, wind, or other electric power generator 20. Customer 10 may be a residential customer or a corporate customer. Electric power provided by a ESP or UDC is provided to customer 10 through an electric meter 30 that is connected to the electric grid with power line 32. In this embodiment, the system 20 is connected through a second meter 40 to customer 10 on the customer side of meter 30. Consequently, when the power generated by generator 20 exceeds the demand by customer 10 the meter 30 operates to decrement the total power consumption indicated on the meter. The reduction in the indicated consumption corresponds to the surplus power generated. The meter increments when the on-site demand exceeds the electric output of the solar or other generator.

In this embodiment it is also preferred that customer 10 purchase the electricity from the same ESP or UDC to which the solar, wind, or other electric power is sold. Since there is a second meter 40 located between the generator 20 and the customer 10, the ESP or UDC and the customer do not need to estimate the amount of power generated in a given period of time. The reading of the second meter 40 would be used to periodically determine the power generated by generator 20. The reading of the first meter 30 would determine the power consumed from the electric grid and would be utilized to determine the transmission and distribution costs for that period. A combination of the readings from both meter 30 and second meter 40 would be used, in this embodiment, to determine the total power consumed. The consumer 10 could then be billed for the total power consumed and receive a payment or credit for the power generated as illustrated in FIG. 2.

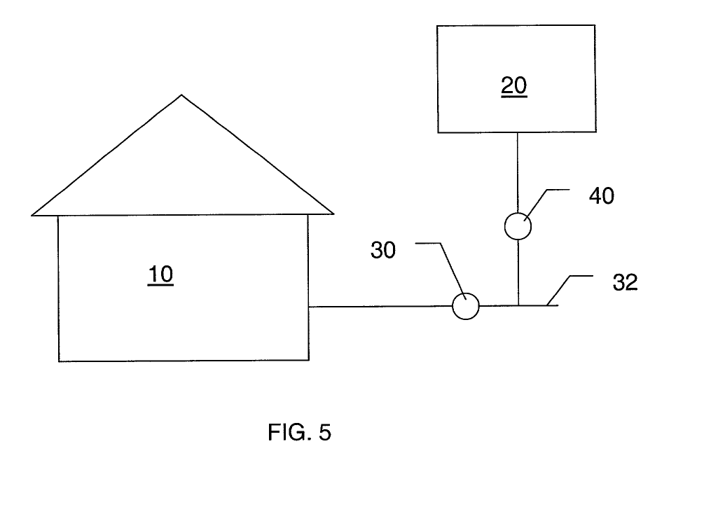

FIG. 5 illustrates a third embodiment of an apparatus that may be employed to implement the present invention. A customer 10 uses either electric power generated by a solar, wind, or other electric power generator 20 or from the electric grid through power line 32. Customer 10 may be a residential customer or a corporate customer. Electric power provided by the ESP or UDC from whom customer 10 purchases their power is provided to customer 10 through an electric meter 30 that is connected to the electric grid with power line 32. In this embodiment, the system 20 is connected through a second meter 40 either directly to the electric grid, between the grid and meter 30, or on the utility side of meter 30.

In this embodiment it is preferred that customer 10 purchase the electricity from a ESP or UDC different from the ESP or UDC to which the solar, wind, or other electric power is sold. This embodiment may, however, be utilized when customer 10 both purchases power form and sells power to the same ESP or UDC. Since the second meter 40 measures the power generated by generator 20, the ESP or UDC and the customer do not need to estimate the amount of power generated in a given period of time. The reading of the second meter 40 would be used to periodically determine the power generated. The reading of the first meter 30 would determine the power consumed from the electric grid and would be utilized to determine the total cost for the electric power used by consumer 10. The second meter 40 would be used in this embodiment to determine the total power generated. Customer 10 could then receive a payment from the ESP or UDC to which the power generated power was sold. This embodiment may be utilized when the ESP or UDC that was willing to purchase the solar, wind, or other electric power did not sell electric power in the state in which the customer 10 was located. This embodiment, however, may reduce the benefit to customer 10 since customer 10 now pays the transmission and distribution charge for the total power consumed instead of the net power consumed. The increase in the transmission and distribution charge, however, could be offset by the ESP or UDC paying a higher rate for the power purchased from customer 10.

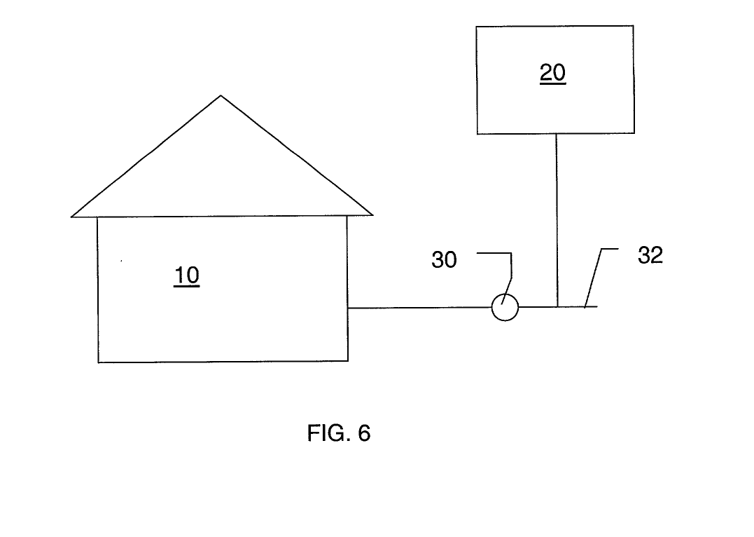

FIG. 6 illustrates a third embodiment of an apparatus that may be employed in the present invention. Customer 10 uses either electric power generated by a solar, wind, or other electric power generator 20 or from the electric grid through power line 32. Customer 10 may be a residential customer or a corporate customer. Electric power provided by an ESP or UDC together with power generated from the solar, wind, or other electric power generator 20 is provided to customer 10 through an electric meter 30 that is connected to the electric grid with power line 32. In this embodiment, the generator 20 is connected either directly to the electric grid or between the grid and meter 30.

In this embodiment it is preferred that customer 10 purchase the electricity from a ESP or UDC different from the ESP or UDC to which the solar, wind, or other electric power is sold. This embodiment may, however, be utilized when customer 10 both purchases power form and sells power to the same ESP or UDC. Since generator 20 does not have a meter, the ESP or UDC buying the power generated from generator 20 and the customer need to estimate the amount of power generated in a given period of time. The reading of the first meter 30 would determine the power consumed from the electric grid and would be utilized to determine the total cost for the electric power used by consumer 10. The estimate would be used in this embodiment to determine the total power generated. Customer 10 could then receive a payment from the ESP or UDC to which the power generated was sold. This embodiment may be utilized when the ESP or UDC that was willing to purchase the solar, wind, or other electric power did not sell electric power in the state in which the consumer 10 was located. This embodiment, however, may reduce the benefit to customer 10 since customer 10 now pays the transmission and distribution charge for the total power consumed instead of the net power consumed. The increase in the transmission and distribution charge, however, could be offset by the ESP or UDC paying a higher rate for the power purchased from customer 10. This embodiment, however, may be difficult to implement in the United States given the current ISO requirement for generators' meter data.

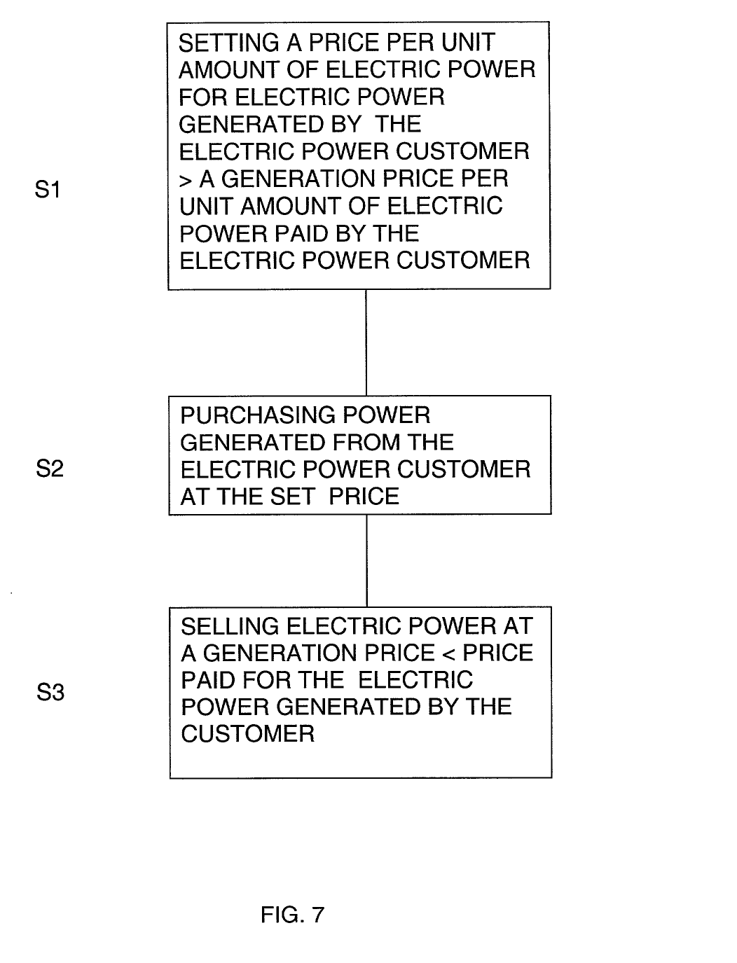

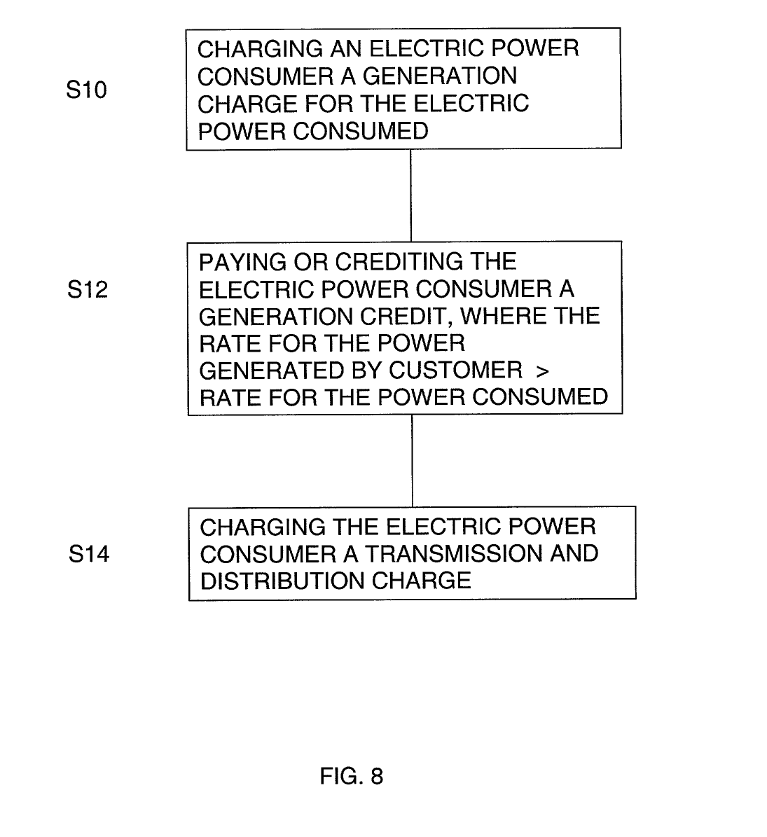

FIGS. 7 and 8 illustrate block diagrams for processes that may be utilized in the above described embodiments. FIG. 7 provides a block diagram of a process where the ESP or UDC sets the rate for the electric power generated by the customer 10 with generator 20 at a rate that is higher than the generation rate paid by the customer 10 for the electric power consumed by the customer 10 in step S1. By setting the rates in this manner the expected payback period for the generator 20 is reduced. This rate difference is also shown in FIG. 2. The ESP or UDC would then purchase the electric power from the customer 10 at the set price in step S2. The ESP or UDC may sell electric power to customer 10 in step S3. While it may be desired, as discussed above, to buy and sell power to the same ESP or UDC it is not required.

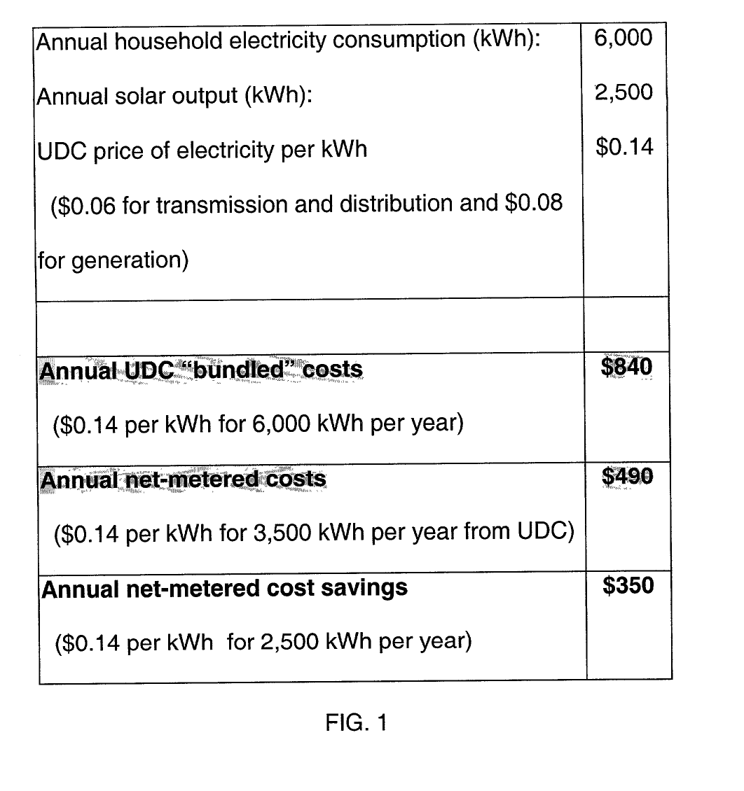

FIG. 8 provides a second block diagram for a second process utilized in the present invention. This is the preferred process when the ESP or UDC that provided power to customer 10 also buys the power generated by customer 10 with generator 20. In this diagram, an ESP or UDC charges customer 10 for their total electrical power consumption in step S10. The ESP or UDC also pays or credits customer 10 for the power generated with generator 20. The rate paid by the ESP to customer 10 for the power generated by generator 20 exceeds the generation rate paid by the customer 10 to the ESP or UDC for the power consumed or used by customer 10. Since the rate paid by the ESP or UDC is greater that the generation rate paid by the customer 10 the payback period for generator 20 is shorter than the payback period using net metering. In net metering customer 10 is effectively paid by the ESP or UDC the same generation rate that the customer 10 pays the UDC or ESP (see FIG. 1). The ESP or UDC may charge the customer 10 a transmission and distribution charge. This charge may be on either the electric power consumed by customer 10 or on the net power provided by the ESP or UDC (net power provided is the power consumed reduced by the power generated). In the event that the transmission and distribution charge is based on the net power provided then customer 10 would pay a reduced transmission and distribution charge compared to a transmission and distribution charge based on the total power consumed. The reduced charge is shown in FIG. 2.

In summary, numerous benefits have been described which results from the invention. The foregoing description of the several embodiments of the invention has been presented for the purposes of illustration and description. It is not intended to be exhaustive or to limit the invention to a precise form disclosed. Obvious modifications or variations are possible in light of the above teachings. The embodiments were chosen in order to best illustrate the principles of the invention and its practical application to thereby enable one of ordinary skill in the art to utilize the invention in various embodiments and with various modifications as suited to the particular use contemplated. It is intended that the scope of the invention be defined by the claims appended hereto.

What is claimed is:

1. An electric power generation system comprising:
an electric power generator;
a second electric meter, the second meter is connected to the electric power generator and the electric power consumer, the second meter measures the electric power generated by the electric power generation system; and
a first electric meter, the first meter connected to an distribution power line, the power line supplies electric power from an electric grid and receives surplus power from the power generation system, wherein the first meter measures a net electric power provided to the electric power consumer through the power line.

2. The system of claim 1, wherein the electric power generator is a solar photovoltaic system.

3. The system of claim 1, wherein the electric power generator is a wind system.

4. The system of claim 1, wherein the electric power generator is a hydroelectric system.

5. An electric power generation system comprising:
an electric power generator;
a second electric meter, the second meter is connected to the electric power generator and either an electric grid, a utility side of a first meter, or a connection point between the first meter and a electric distribution power line, the second meter measures the electric power generated by the electric power generator; and
the first meter is connected to the electric distribution power line, the power line supplies electric power from the electric grid, and the first meter measures the electric power utilized by the electric power consumer.

6. The system of claim 5, wherein the electric power generator is a solar photovoltaic system.

7. The system of claim 5, wherein the electric power generator is a wind system.

8. The system of claim 5, wherein the electric power generator is a hydroelectric system.

9. A method of purchassing electric power from an electric power customer who generates electric power, the method comprising:
setting a price per unit amount of electric power for electric power generated by the electric power customer at a price per unit amount of electric power that exceeds a generation price per unit amount of electric power paid by the electric power customer for electric power consumed; and
purchasing the generated electric power from the electric power customer at the set price per unit amount of electric power.

10. A method of reducing a customer's net electric power payment to an ESP or UDC, the method comprising:
providing an electric power generation system; and
selling the electric power produced by the power generation system at a price per unit of electric power that exceeds the generation price per unit amount of electric power paid by the customer for electric power consumed.

11. The method of claim 10, further comprising:
purchasing electric power at a generation price per unit amount of electric power that is below the price per unit amount of electric power received for the electric power produced by the power generation system.

12. A method of billing for electric power consumed and compensating a customer for electric power produced, the method comprising:
charging an electric power consumer a generation charge for the total electric power consumed, the generation charge determined by multiplying a first rate by the amount of electric power consumed or estimated to have been consumed; and
paying or crediting the electric power consumer a generation fee, the generation fee determined by multiplying a second rate by the amount of electric power generated or estimated to have been generated, the second rate being higher than the first rate.

13. The method of claim 12, further comprising:
charging the electric power consumer a transmission and distribution charge, the transmission and distribution charge determined by multiplying a third rate by an amount of electric power transmitted to the electric consumer or estimated to have been transmitted to the electric power consumer.

14. The method of claim 13, wherein the amount of electric power transmitted to the electric consumer or estimated to have been transmitted to the electric power consumer is the amount of electric power consumed or estimated to have been consumed reduced by the amount of electric power generated or estimated to have been generated.
